(19) United States
(12) Patent Application Publication
(10) Pub. No.: US 2009/0247135 A1
(43) Pub. Date: Oct. 1, 2009

(54) INFORMATION PROCESSING DEVICE

(75) Inventor: Yoshinori YUKI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/364,591

(22) Filed: Feb. 3, 2009

(30) Foreign Application Priority Data
Apr. 1, 2008 (JP) P2008-094804

(51) Int. Cl. H04M 3/42

(52) U.S. Cl. 455/414.2

(57) ABSTRACT

An information processing device such as cellular phone includes an input unit to input channel information, a transmitting unit to send out, on the basis of the channel information inputted by the input unit and an inputted time, desired information demanding for the channel information, the time information, and information regarding to a WWW site in a television or a radio broadcast associated with the channel information and the time information, a receiving unit to receive URL information extracted based on an information sent by the transmitting unit, and a display unit to access the WWW site based on the URL information received by the receiving unit and to display the WWW site.

### BACKGROUND OF THE INVENTION

1. Field of the Invention

The present invention relates to an information processing device such as, for example, cellular phone (or mobile phone) capable of simply browsing a WWW site when a user is presented with the WWW site during a time of listening to and watching a television and a radio.

2. Description of the Related Art

Recently, along with progress in diffusion of Internet, during a time of broadcasting of television and radio, a retrieval password or a URL of a WWW site may be included in programs and commercial messages for inducing a user to a predetermined WWW site.

On the basis of information, for browsing such a www site by a user, it has been necessary that an information instrument, such as a PC, is actuated so as to input a retrieval password or a URL of a WWW site. Further, when the user is to browse the WWW site presented in the programs or commercial messages, the user may forget the required information, so that the improvement in convenience during the accessing to the WWW site has been demanded.

Then, a communication system has been proposed in that resources on Internet presented through multiplex broadcast waves can be simply used by a cellular phone (see Patent Publication 1: Japanese Unexamined Patent Application Publication No. 2003-244082). In this communication system, resource information included in the broadcast waves is received and extracted by the broadcasting receiver, the extracted resource information is transferred to a cellular phone, the cellular phone receives the transferred resource information to hold the information, and on the basis of the held resource information, a user uses the resource on Internet via a cellular phone communications network.

Information processing devices such as cellular phones have been demanded to be capable of simply browsing a WWW site, when a user is listening or watching a television or a radio, using a retrieval password or a URL included in programs or commercial messages of the television or the radio.

### SUMMARY OF THE INVENTION

The present invention has been made in consideration of the above circumstances encountered in the prior art, and it is an object of the present invention to provide an information processing device such as cellular phone capable of browsing a WWW site by user's simple operation so as to improve the convenience in access to the WWW site, when a retrieval keyword or a URL regarding to the WWW site is included in broadcast waves of a television and a radio.

This and other objects can be achieved according to the present invention by providing an information processing device which comprises:

an input unit configured to input channel information;

a transmitting unit configured to send out, on a basis of the channel information inputted by the input unit and an inputted time, desired information demanding for the channel information, the time information, and information regarding to a WWW site in a television or a radio broadcast associated with the channel information and the time information;

a receiving unit configured to receive URL information extracted based on an information sent by the transmitting unit; and

a display unit configured to access the WWW site based on the URL information received by the receiving unit so as to display the WWW site.

In a preferred embodiment of the above aspect, the transmitting unit may be configured to send out the information of the broadcasting date/time, the broadcasting area and the channel of the broadcast, and the receiving unit may be configured to extract the URL information based on the information sent by the transmitting unit of the broadcasting date/time, the broadcasting area and the channel.

The transmitting unit may be configured to send out the information of the broadcasting date/time and the broadcasting area, the receiving unit is configured to extract each piece of the URL information for each channel of the broadcast based on the information sent by the transmitting unit of the broadcasting date/time and the broadcasting area, and the display unit is configured to display each piece of the URL information for each of the channel of the broadcast.

The transmitting unit may be configured to send out the information of the broadcasting area and the channel of the broadcast, and the receiving unit is configured to extract the URL information based on the information of the broadcasting area and the channel sent by the transmitting unit and the date/time at that time.

The receiving unit may be configured to receive the information regarding to the WWW site of a URL along with the URL information.

The transmitting unit may have a structure for sending out positional information or GPS information from a base station as the broadcasting area.

In the information processing device according to the present invention of the aspect mentioned above, when a retrieval keyword and a URL regarding to a WWW site are included in television or radio broadcast waves, a user can access the WWW site with simple operation, thus improving the convenience in access to a WWW site.

The nature and further characteristic features will be made clearer from the following descriptions made with reference to the accompanying drawings.

### BRIEF DESCRIPTION OF THE DRAWINGS

In the accompanying drawings:

FIG. 1 is an illustration of a system diagram showing a network system incorporating a cellular phone as one preferred example of an information processing device according to the present invention;

FIG. 2A is a front view of the cellular phone, in an opened state, according to the present invention, and FIG. 2B is a side view of the cellular phone, in the opened state, according to the present invention;

FIG. 3A is a front view of the cellular phone, in a closed state, according to the present invention, and FIG. 3B is a side view of the cellular phone, in the closed state, according to the present invention;

FIG. 4 is a functional block diagram of the cellular phone according to the present invention;

FIG. 5 is a functional block diagram of a search server;

FIG. 6 is a data table showing digitized terrestrial URL information;

FIG. 7 is a data table showing radio URL information;

FIG. 8 is a drawing illustrating the search processing in the cellular phone according to the present invention;

FIG. 9 is a flowchart of the sequence of the search processing in the cellular phone according to the present invention; and

FIG. 10 is a flowchart of the sequence of the search processing in the search server.

### DESCRIPTION OF THE PREFERRED EMBODIMENT

An embodiment of an information processing device according to the present invention will be described hereunder with reference to the accompanying drawings, in which the information processing device is typically represented by a cellular phone as a preferred embodiment.

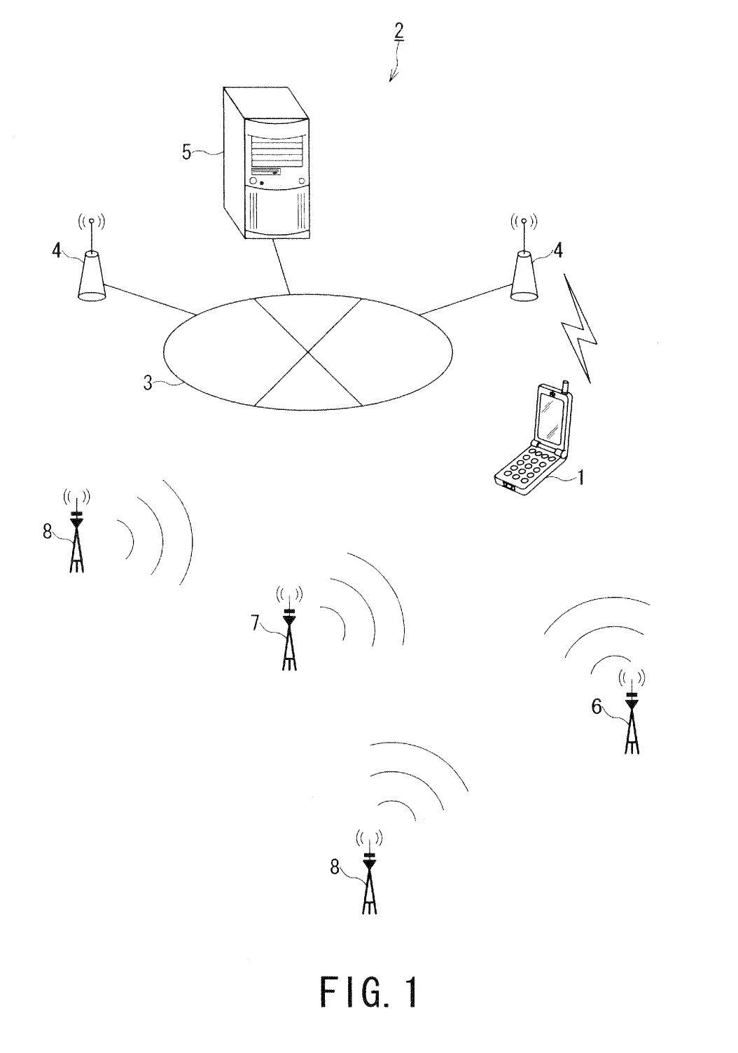

As shown in FIG. 1, the network system 2 includes a network 3, and in this embodiment, the network 3 is, for example, a cellular phone communications network, and there are a plurality of base stations 4 within a communication service area of the cellular phone 1, the base station 4 being connected to the network 3 via a wire circuit as a fixed radio station.

The cellular phone 1 makes wireless connection with the base stations 4 adopting a W-CDMA (Wideband-Code Division Multiple Access) system, so that the cellular phone 1 establishes voice communications and data communications with other cellular phones via the base stations 4.

The network system 2 includes a search server 5, and the cellular phone 1 achieves data communications with the search server 5 via the base stations 4. When the search server 5, having a database, receives data from the cellular phone 1, the search server 5 extracts the corresponding data from the database so as to transmit the extracted data to the cellular phone 1.

The network system 2 includes a broadcast station 6 of a digitized terrestrial broadcast (including a digitized terrestrial one-segment broadcast), so that the cellular phone 1 receives the digitized terrestrial broadcast waves from the broadcast station 6 for listening to and watching the broadcast Similarly, the network system 2 includes a radio broadcast station 7, so that the cellular phone 1 receives the radio broadcast waves from the radio broadcast station 7 for listening to the broadcast.

The network system 2 also includes a GPS (global positioning system) broadcast station 8. In a GPS system, a receiver receives radio signals from a plurality of satellites, and the time difference of the arrival radio wave is used for calculating the range difference relative to the individual satellites so as to determine the present position information by obtaining the intersection of hyperboloids determined by the geometric locus of the range difference.

The cellular phone 1 obtains the GPS information showing the present position, such as latitude, longitude, and altitude, from the GPS broadcast station 8. For determining the present position information, not only a method of using the function of the GPS broadcast station 8, but also a method of calculating inside the cellular phone 1 by being provided with the calculation function of the GPS broadcast station 8.

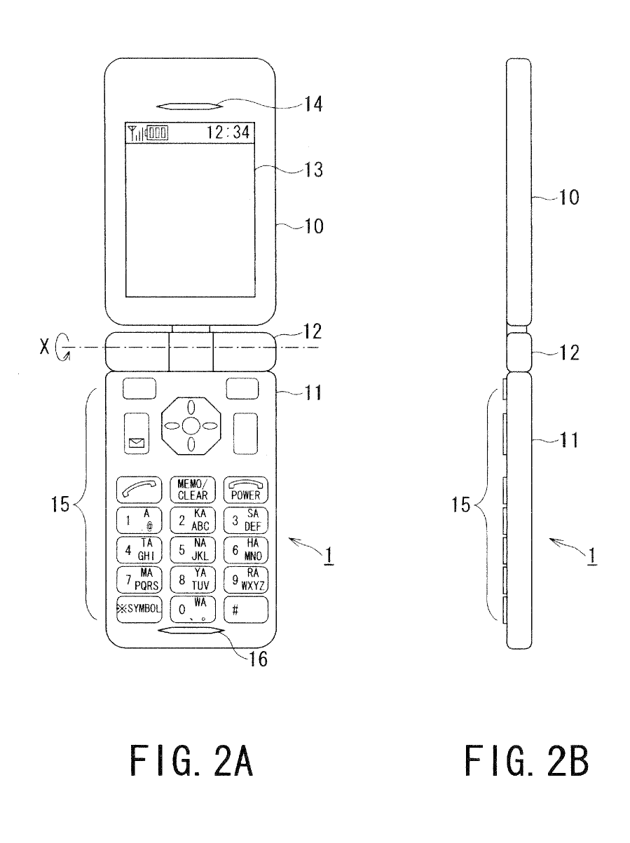

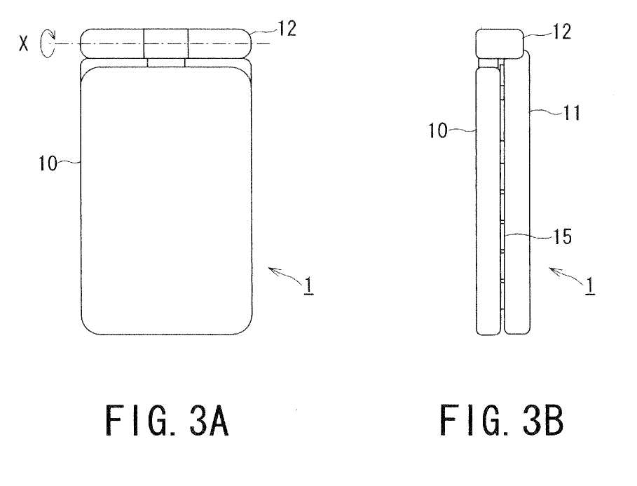

The configuration of the cellular phone 1 is herein described with reference to FIGS. 2A to 3B.

The cellular phone 1, as shown FIGS. 2A to 3B, mainly includes a rectangular plate-shaped upper casing 10 and a lower casing 11 having substantially the same shape as that of the upper casing 10, and in the closed state, the upper casing 10 and the lower casing 11 are overlapped to cover one plane with each other. The upper casing 10 and the lower casing 11 are hinge-connected together by means of a hinge 12, and the upper casing 10 is rotatable about the hinge portion 12 with respect to the lower casing 11 by a predetermined angle in X direction of FIG. 2A. In the cellular phone 1, by rotating the upper casing 10 with respect to the lower casing 11, the state is transformed from the closed state to the opened state, and vice versa.

The inner surface (the surface opposing the lower casing 11) of the upper casing 10 is provided with a display 13 for displaying the information including characters and images. The display 13 may be a liquid crystal display or an EL (electro-luminescence) display. A speaker 14 is also provided on the inner surface of the upper casing 10 for voice outputting.

The display 13 and the speaker 14 are covered with the lower casing 11 not to be exposed outside when the cellular phone 1 is in the closed state, whereas when the cellular phone 1 is rotated to the lower casing 11 to have the opened state, these components are exposed outside.

The inner surface (the surface opposing the upper casing 10) of the lower casing 11 is provided with operation keys 15 including a power supply key for turning on/off the power supply, a calling key for calling processing, a ten-key for inputting numerals and characters, and shortcut keys for actuating the mail and web functions. A microphone 16 is also provided on the inner surface of the lower casing 11 for collecting voice.

The operation keys 15 and the microphone 16 are covered with the upper casing 10 not to be exposed outside when the cellular phone 1 is in the closed state, whereas when the cellular phone 1 is rotated to the lower casing 11 to have the opened state, these components are exposed outside.

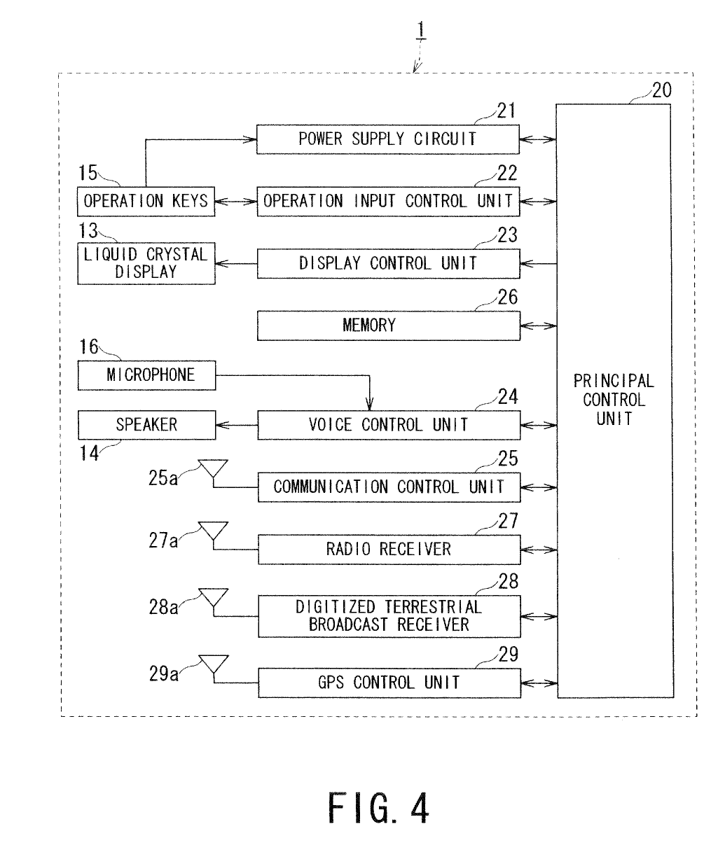

Then, the functions of the cellular phone 1 will be described with reference to the functional block diagram of FIG. 4. As shown in FIG. 4, the cellular phone 1 includes a principle control unit 20, a power supply circuit 21, an operation input control unit 22, a display control unit 23, a voice control unit 24, a communication control unit 25, a memory 26, a radio receiver 27, a digitized terrestrial broadcast receiver 28, and a GPS control unit 29 which are connected together by means of bus so as to be communicated with each other.

The principal control unit 20 includes a CPU (central processing unit) for controlling the cellular phone 1 as a whole as well as performing various kinds of processing, such as the below-mentioned search processing, arithmetic processing, and control processing. The principal control unit 20 always measures the accurate present time and date.

The power supply circuit 21 turns the power supply on/off in response to the input by a user, for example, through the operation keys 15, and when the power supply is turned on, the electric power is supplied to individual components from an electric power supply source (battery, etc.), enabling the cellular phone 1 to be actuated.

The operation input control unit 22 includes an input interface to the operation keys 15. When the operation input control unit 22 detects depression (push-down) of the operation key 15, a signal showing the pushed operation key 15 is produced for transferring the signal to the principal control unit 20. The display control unit 23, including a display interface to the display 13, displays information including a document and images on the display 13 based on the control of the principal control unit 20.

The voice control unit 24 produces an analog voice signal from a voice collected by the microphone 16 based on the control of the principal control unit 20 so as to convert an analog voice signal into a digitized voice signal. When the voice control unit 24 obtains the digitized voice signal, the voice control unit 24 also converts the digitized voice signal into the analog voice signal based on the control of the principal control unit 20 so as to output the voice from the speaker 14.

The communication control unit 25 performs the spectrum back-diffusion of the received signal from the base station 4 via an antenna 25a so as to restore data based on the control of the principal control unit 20. The data is transmitted to the voice control unit 24 by the instruction of the principal control unit 20 and is outputted from the speaker 14. The data is then transmitted to the display control unit 23, displayed on the display 13, and then stored in the memory 26.

Further, when the communication control unit 25 obtains the voice data collected by the microphone 16, the data inputted via the operation keys 15, or the data stored in the memory 26 based on the control of the principal control unit 20, the communication control unit 25 performs the spectrum diffusion on the data so as to transmit the data to the base station 4 via the antenna 25a. The communication control unit 25 also acquires the position information periodically from the base station 4 in the vicinity and transmits the position information to the principal control unit 20 based on the control of the principal control unit 20.

The memory 26 includes a ROM (read only memory) for storing a processing program and data necessary for the processing performed by the principal control unit 20, a hard disk, a non-volatile memory, and a RAM (random access memory) for temporarily storing data used during the processing by the principal control unit 20.

The processing program necessary for the below-mentioned search processing by the principal control unit 20 is to be stored in the ROM.

The radio receiver 27, including an antenna 27a, receives radio broadcast waves from the radio broadcast station 7 via the antenna 27a. Then, the radio receiver 27 produces voice signals from the received broadcast waves and performs listening processing for outputting the voice signals with the voice control unit 24 through the speaker 14.

The digitized terrestrial broadcast receiver 28, including an antenna 28a, receives broadcast waves, such as terrestrial One-segment broadcast waves, digitized terrestrial broadcast waves, and terrestrial Three-segment radio broadcast waves, via the antenna 28a. Then, the digitized terrestrial broadcast receiver 28 divides the received broadcast wave data into voice signals and image signals, so that the image signals are displayed on the display 13 by the display control unit 23 while the voice signals are outputted through the speaker 14 by the voice control unit 24 for performing the listening processing.

The GPS control unit 29 includes an antenna 29a for receiving GPS information sent on the air from the GPS broadcast station 8, and on the basis of the GPS information received via the antenna 29a, the GPS control unit 29 produces the information showing the present position of the cellular phone 1 so as to transmit the information to the principal control unit 20.

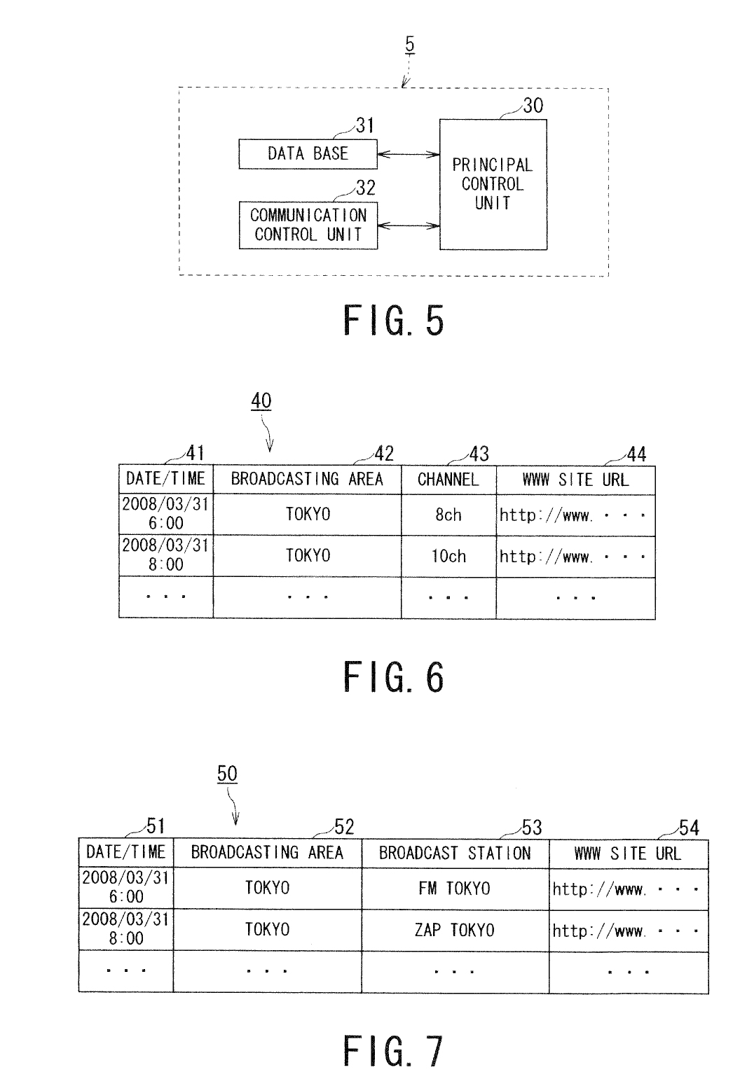

Hereunder, the function of the search server 5 will be described with reference to the function block diagram of FIG. 5.

The search server 5, as shown in FIG. 5, includes a principal control unit 30 for controlling the whole search server 5, a data base 31 for storing data necessary for the control by the principal control unit 30, and a communication control unit 32 for controlling the communication with the cellular phone 1 via the network 3 which are connected together by means of bus so as to be communicated with each other.

The principal control unit 30 of the search server 5, including a CPU, controls the search server 5 as a whole while performing various kinds of processing, such as the below-mentioned search processing, arithmetic processing, and control processing.

The data base 31 stores digitized terrestrial URL information 40 showing a Web site URL presented in programs of a digitized terrestrial broadcast. The digitized terrestrial URL information 40 includes time/date information 41 showing the time and date at the time on air, area information 42 showing the broadcasting area, channel information 43 showing the broadcasting channel, and URL information 44 showing the Web site URL presented in the broadcast that are associated with each other.

For example, according to the digitized terrestrial URL information 40, shown in FIG. 6, the time/date information 41 of “2008/03/31 6:00”, the area information 42 of “Tokyo”, the channel information 43 of “8ch”, and the URL information 44 of “http://www. . . . ” are corresponding to each other. This means that the Web site of http://www. . . . is presented in the program or the commercial message broadcast on the 8 channel at 6:00 Mar. 31, 2008 in Tokyo area.

The data base 31 also stores radio URL information 50 showing a Web site URL presented in programs of a radio broadcast. The radio URL information 50 includes time/date information 51 showing the time and date at on air, area information 52 showing the broadcasting area, broadcast station information 53 showing the broadcasting station, and URL information 54 showing the Web site URL presented in the broadcasting which are associated with each other.

For example, according to the radio URL information 50, shown in FIG. 7, the time/date information 51 of “2008/03/31 6:00”, the area information 52 of “Tokyo”, the broadcast station information 53 of “FM Tokyo”, and the URL information 54 of “http://www. . . . ” are associated with each other. This means that the Web site of http://www. . . . is presented in the program or the commercial message broadcast on the FM Tokyo at 6:00 Mar. 31, 2008 in Tokyo area.

The communication control unit 32, including a communication interface to the network 3, transmits the data received via the network 3 to the principal control unit 30 as well as sends out data via the network 3 based on the control of the principal control unit 30.

In programs or commercial messages of a digitized terrestrial broadcast and a radio broadcast, there may be situations that a predetermined WWW site is induced with a designated keyword. When a user is watching or listening to a digitized terrestrial broadcast or a radio broadcast including a presented WWW site, if the user accesses the WWW site in the cellular phone 1 by a conventional method, it has been required for the cellular phone 1 to actuate a Web browser, to be connected to a search engine, and to input a keyword. However, it may be significantly troublesome for the user in the cellular phone 1 to actuate the Web browser and to input the keyword.

The network system 2 herein has a function to eliminate the user's troublesome access operation to the WWW site. In the function, when the informations about broadcast programs or commercial messages are sent to the search server 5 during the broadcasting of the digitized terrestrial broadcast or the radio broadcast, the search server 5 returns the WWW site information presented in the broadcast programs or commercial messages to the cellular phone 1.

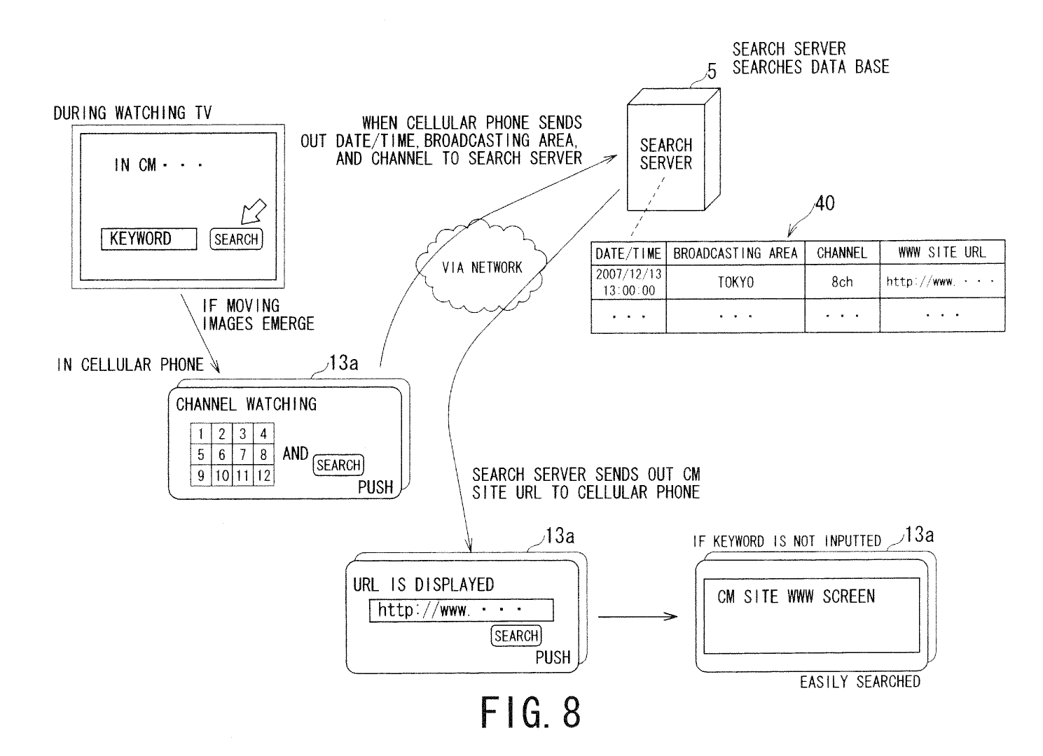

Namely, as shown in FIG. 8, during the broadcasting of the digitized terrestrial broadcast or the radio broadcast including a presented WWW site, if a user instructs a WWW site to be searched, the cellular phone 1 sends out the informations about broadcast programs or commercial messages (the broadcasting date/time, the area, and the channel) to the search server 5. On the basis of the received information, the search server 5 extracts the information regarding to the WWW site (URL, etc.) so as to send out the extracted information to the cellular phone 1. When the cellular phone 1 receives the information about the WWW site from the search server 5, the cellular phone 1 performs access processing to the WWW site based on the information.

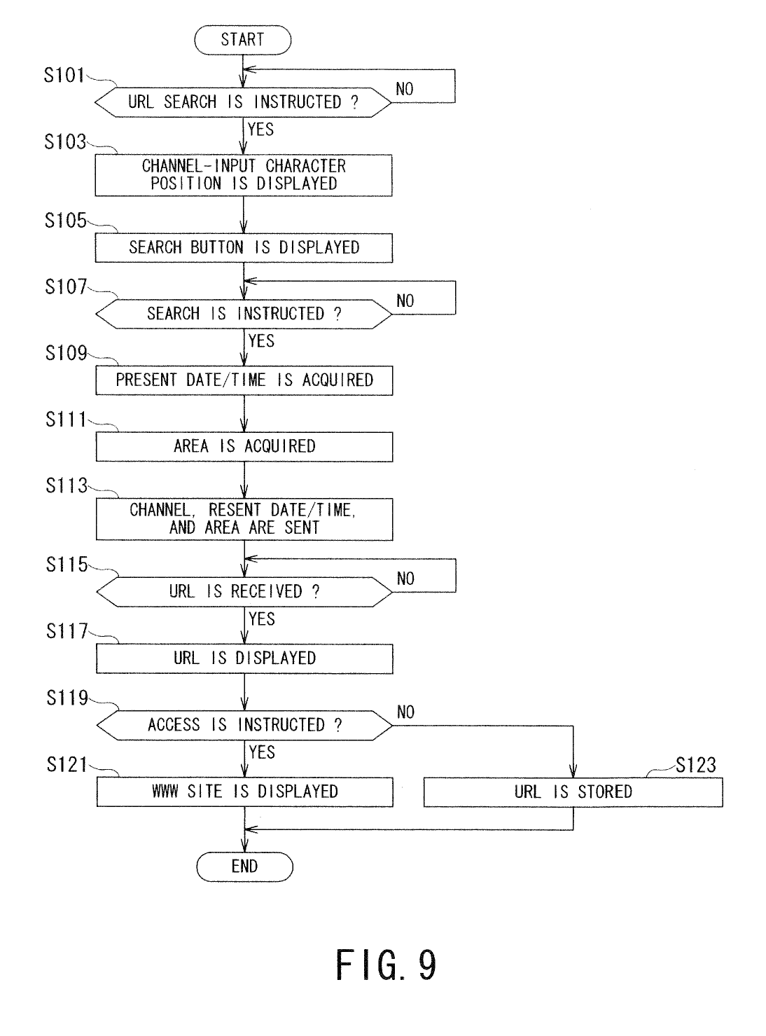

The procedure of the search processing by the cellular phone 1 when being instructed to search a WWW site during the broadcasting of a digitized terrestrial broadcast or a radio broadcast will be described hereunder with reference to the flowchart of FIG. 9.

The following description exemplifies a case where a user is to access the WWW site when watching the digitized terrestrial broadcast including the presented WWW site. In the description, the word “Step” in “Step S101”, for example, is omitted below.

The principal control unit 20 of the cellular phone 1 starts search-processing based on the instruction to search a WWW site during the broadcasting of the digitized terrestrial broadcast or the radio broadcast including a presented WWW site. First, the principal control unit 20 determines whether URL searching is instructed by a user or not (S101). At this time, the principal control unit 20 determines the instructions to search the URL on the basis of the depression or push-down of a predetermined operation key 15. In the searching, the URL is not instructed (“NO” at S101), the principal control unit 20 waits ready as it is.

In the searching, when the URL is instructed (“YES” at S101), the principal control unit 20 displays a channel-input character position to be inputted with channel information on a display screen 13a of the display 13 (S103). The principal control unit 20 also displays a search button on the display screen 13a (S105). At this time, on the display screen 13a, a plurality of channels are displayed as an option along with the search button, as shown in FIG. 8, so that the user pricks down the search button after selecting the channel with the operation key 15.

The principal control unit 20 determines whether the search is instructed or not (S107). At this time, on the basis of the selection of the search button by the user, the search is determined to be instructed. Alternatively, if a predetermined operation key 15 is associated with the search processing, the search may also be determined to be instructed based on the push-down of the predetermined operation key 15. If the search is not instructed (“NO” at S107), the principal control unit 20 waits until the search instructions are generated.

When the search is instructed (“YES” at S107), the principal control unit 20 obtains the information showing the present date/time (S109), and also acquires the information showing the area (S111). At this time, the principal control unit 20 may acquire the present position information from the setting information in the cellular phone 1 for watching the digitized terrestrial One-segment broadcast or from the GPS control unit 29. Alternatively, the principal control unit 20 may also acquire the position information showing the base station 4 in the vicinity from the communication control unit 25. Alternatively, the user may input the position information via the operation keys 15, or the area information may be obtained from the memory 26 which has stored the information in advance.

The principal control unit 20 sends out, to the search server 5, (S113) the information showing the channel selected at S107, the information showing the present date/time acquired at S109, and the information showing the area acquired at S111.

When receiving the information showing the channel, the present date/time, and the area from the cellular phone 1, on the basis of the information, the search server 5 extracts the information showing the URL from the data base 31. Then, the search server 5 sends out the extracted information to the cellular phone 1.

Thus, the principal control unit 20 determines whether the information showing the URL is received from the search server 5 (S115). If the URL is not received (“NO” at S115), the principal control unit 20 waits until receiving the URL. When the URL is received (“YES” at S115), the principal control unit 20 displays the URL on the display 13 (S117).

When the URL searched and extracted by the search server 5 is displayed on the display 13, the user instructs the access to the WWW site of the URL by operating the operation keys 15. Then, the principal control unit 20 determines whether the access is instructed or not by the user (S119). At this time, the principal control unit 20 determines that the access is instructed based on the inputting of a predetermined operation key 15.

When the access is instructed (“YES” at S119), the principal control unit 20 actuates the Web browser so as to display the WWW site on the display 13 (S121) based on the URL received at S115. If the access is not instructed (“NO” at S119), the principal control unit 20 stores the URL received at S115 in the memory 26 in view of the access to the WWW site by the user thereafter (S123).

In such a manner, when the search of the WWW site is instructed during the broadcasting of the digitized terrestrial broadcast or the radio broadcast including the presented WWW site, the cellular phone 1 sends out the information showing the channel, the present date/time, and the broadcasting area to the search server 5 so as to receive the URL of the WWW site from the search server 5, so that the WWW site can be simply accessed by the user using the cellular phone 1.

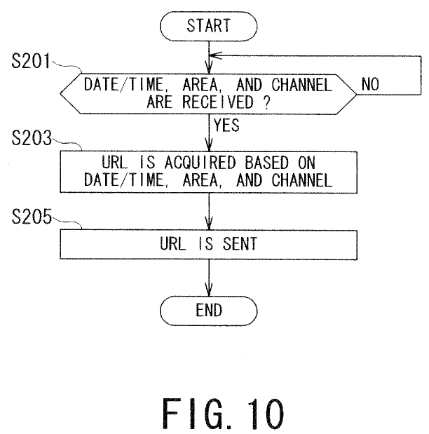

Then, the procedure of the return processing to the cellular phone 1 will be described with reference to the flowchart of FIG. 10, and the return processing is performed by extracting the URL of the WWW site from the information when the search server 5 receives the information showing the channel, the present date/time, and the area from the cellular phone 1.

First, the principal control unit 30 of the search server 5 determines whether the information showing the channel, the present date/time, and the area is received from the cellular phone 1 (S201). At this time, the principal control unit 30 determines the receipt based on the receiving of the information sent from the cellular phone 1 at S113. If the information showing the channel, the present date/time, and the area is not received from the cellular phone 1 (“NO” at S201), the principal control unit 30 waits ready.

When the information showing the channel, the present date/time, and the area is received from the cellular phone 1 (“YES” at S201), the principal control unit 30 acquires, from the digitized terrestrial URL information 40 stored in the data base 31, the URL information 44 associated with the time/date information 41 of the present date/time received at S201, the area information 42 of the broadcasting area, and the channel information 43 of the channel (S203). For example, in the digitized terrestrial URL information 40 shown in FIG. 6, when acquiring the information showing the present date/time of “at 6:00 Mar. 31, 2008”, the broadcasting area of “Tokyo”, and the channel of “8Ch” at S201, the URL information 44 of “http://WWW . . . ” associated with these pieces of information is obtained.

The principal control unit 30 sends out the URL information 44 extracted at S203 to the cellular phone 1 (S205). Then, the cellular phone 1 receives the URL information 44 at S115.

In such a manner, by storing the URL of the presented WWW site in association with the broadcasting date/time, the broadcasting area, and the channel, when receiving the information showing the channel, the present date/time, and the area, the search server 5 extracts the URL of the WWW site from these pieces of information so as to return the URL to the cellular phone 1.

A case where a user is watching a digitized terrestrial broadcast including a presented WWW site is exemplified according to the embodiment. And alternatively, during the listening of a radio broadcast including a presented WWW site, the same processing may be performed, and in this case, the cellular phone 1 displays a broadcast station-input character position instead of the channel at S103 and sends out the information showing the broadcast station instead of the channel at S113. The search server 5 also acquires the information showing the URL from the radio URL information 50 based on the information showing the date/time, the area, and the broadcast station at S203.

A case where the cellular phone 1 displays the WWW site at S121 based on the access instruction by the user at S119 is exemplified according to the embodiment. Alternatively, the WWW site may also be displayed based on the receiving the URL at S115.

Further, the cellular phone 1 may send out only the date/time (or the date/time and the broadcasting area) to the search server 5 at S113, and the search server 5 may search the data base 31 based on the date/time (or the date/time and the broadcasting area) at S203 so as to extract a plurality of pieces of the URL information 44 (the URL information 44 associated with each of the Channel information 43) possibly corresponding to this nearest date/time for sending them to the cellular phone 1 at S205. The cellular phone 1 received the plurality of pieces of the URL information 44 at S115 may display the list of the plurality of pieces of the URL information 44 at S117.

Furthermore, the cellular phone 1 may send out the broadcasting area and the broadcasting channel to the search server 5 at S113, and the search server 5 may search the data base 31 based on the broadcasting area, the broadcasting channel, and the present date/time at S203 so as to extract a plurality of pieces of the URL information 44 possibly corresponding to this nearest date/time for sending them to the cellular phone 1 at S205. The cellular phone 1 receiving the plurality of pieces of the URL information 44 at S115 may display the list of the plurality of pieces of the URL information 44 at S117.

A case where the URL information is extracted based on the present date/time is exemplified according to the embodiment. Alternatively, in view of a user searching the WWW site at a time elapsed since watching the broadcast, the channel and the broadcasting date/time may also be inputted at S103. In this case, the inputted broadcasting date/time is sent instead of the present date/time at S113. Then, the search server 5 extracts the URL based on the broadcasting date/time, the broadcasting area, and the channel.

Furthermore, the search server 5 stores the positional information on the basis of the base station 4 of the cellular phone 1, the GPS information, and the area associated with the broadcasting area, and when acquiring the positional information on the basis of the base station 4 of the cellular phone 1, the GPS information, and the area, the broadcasting area may be determined by these pieces of information.

A case where the search server 5 sends out only the URL information 44 is exemplified according to the embodiment. However, the invention is not limited to such embodiment, and the information showing the keyword and the name of the program may also be sent along with the URL information 44. Thus, when a plurality of pieces of the URL information 44 are extracted at S203, a user may select a desired piece of the URL information 44 from the keyword and the name of the program.

The URL information to be stored in the data base 31 of the search server 5 may be accumulated during the digitized terrestrial broadcasting or the radio broadcasting, or it may also be assembled by acquiring the information from an advertising agent. It may rather be realistic to acquire the information from the advertizing agent.

In the cellular phone 1 according to the embodiment of the present invention, when a retrieval keyword and a URL regarding to a WWW site are included in television or radio broadcasting waves, a user can access the WWW site with simple operation, thus improving the convenience in access to a WWW site.

It is further to be noted that the information processing device of the present invention is not limited to the cellular phone exemplified as one preferred embodiment of the present invention, and arbitrary communication terminals, such as a PHS (personal handyphone system), a PDA (personal digital assistants), a portable television, a portable game machine, and a portable music player, may be incorporated in the present invention.

What is claimed is:

1. An information processing device comprising:
an input unit configured to input channel information;
a transmitting unit configured to send out, on a basis of the channel information inputted by the input unit and an inputted time, desired information demanding for the channel information, the time information, and information regarding to a WWW site in a television or a radio broadcast associated with the channel information and the time information;
a receiving unit configured to receive URL information extracted based on an information sent by the transmitting unit; and
a display unit configured to access the WWW site based on the URL information received by the receiving unit so as to display the WWW site.

2. The information processing device according to claim 1, wherein the transmitting unit is configured to send out the information of the broadcasting date/time, the broadcasting area and the channel of the broadcast, and the receiving unit is configured to extract the URL information based on the information sent by the transmitting unit of the broadcasting date/time, the broadcasting area and the channel.

3. The information processing device according to claim 1, wherein the transmitting unit is configured to send out the information of the broadcasting date/time and the broadcasting area, the receiving unit is configured to extract each piece of the URL information for each channel of the broadcast based on the information sent by the transmitting unit of the broadcasting date/time and the broadcasting area, and the display unit is configured to display each piece of the URL information for each of the channel of the broadcast.

4. The information processing device according to claim 1, wherein the transmitting unit is configured to send out the information of the broadcasting area and the channel of the broadcast, and the receiving unit is configured to extract the URL information based on the information of the broadcasting area and the channel sent by the transmitting unit and the date/time at that time.

5. The information processing device according to claim 1, wherein the receiving unit is configured to receive the information regarding to the WWW site of a URL along with the URL information.

6. The information processing device according to claim 1, wherein the transmitting unit sends out positional information or GPS information from a base station as the broadcasting area.
